(19) United States
(12) Patent Application Publication
(10) Pub. No.: US 2024/0165542 A1
(43) Pub. Date: May 23, 2024

(54) HYDROCYCLONE DEGASSING DEVICE

(71) Applicant: R + L UG (HAFTUNGSBESCHRÄNKT), Ortsteil Höhenmoos (DE)

(72) Inventors: Markus Bernhard LANG, München (DE); Robert STAUDACHER, Rohrdorf (DE); Christian WAGNER, Rosenheim (DE)

(21) Appl. No.: 18/551,565

(22) PCT Filed: Mar. 25, 2023
(86) PCT No.: PCT/EP2022/057957

§ 371 Date: Sep. 20, 2023

(30) Foreign Application Priority Data
Mar. 26, 2021 (DE) 10 2021 107 660.9

(51) Int. Cl. B01D 19/00

(52) U.S. Cl. CPC B01D 19/0057; B01D 19/0036; B01D 19/0063

(57) ABSTRACT

A hydrocyclone degassing device for degassing a liquid; having comprises a liquid pump and having a degassing container, in which an outer liquid cyclone and an inner gas cyclone are formed along an axis of rotation, wherein the degassing container comprises at least one inlet for the liquid, at least one outlet for the liquid and at least one extraction port for extracting gas. The outlet of the degassing container is in hydraulic communication with the suction side of the liquid pump.

The present invention relates to a hydrocyclone degassing device for degassing a liquid.

Hydrocyclone degassing is a vacuum degassing process in which the liquid to be degassed is brought into contact with a negative pressure to remove the gases contained in the liquid.

Important criteria for the efficiency of vacuum degassing are a large contact area between the liquid to be degassed and the vacuum, the lowest possible pressure level, and the longest possible residence time.

In the field of vacuum degassing, a number of different processes already exist, each with specific advantages and disadvantages.

On the one hand, degassing can take place via a semi-permeable membrane with or without stripping gas. This enables a very high degassing performance and the removal of dissolved gases down to the range of trace gases. Furthermore, it is a continuous process. However, vacuum degassing via a semi-permeable membrane is susceptible to fouling and only makes sense with pre-cleaned liquids. Furthermore, there are high acquisition costs.

Another technique uses vacuum spray tube degassers, in which the liquid is sprayed in a vacuum. Here, too, a high degassing performance can be achieved. However, the process is also susceptible to fouling because the degassing performance depends on the spray nozzle, which requires narrow cross-sections. In addition, it is a discontinuous process, which means that it cannot be purged.

Furthermore, degassing can be performed according to the injector principle by lowering the pressure through high flow velocities.

In hydrocyclone degassing, the liquid is fed into a degassing container in which an outer liquid cyclone and an inner gas cyclone are formed due to the flow geometry used. Gas can now be extracted from the gas cyclone by applying a vacuum. Hydrocyclone degassing places low demands on water quality and therefore tolerates fouling better than the processes mentioned above. Furthermore, it is a continuous process, so a purge function is provided. However, with prior art hydrocyclone degassing devices, the degassing performance was relatively low.

DE 36 41 781 A1 shows a hydrocyclone degassing device in which both the feed pipe and the discharge pipe are arranged tangentially to the jacket of the degassing container. The liquid is fed to the hydrocyclone at a minimum pressure of 6 to 8 bar.

Patent document GB 2 440 726 A shows a hydrocyclone degassing device with a special geometry of the degassing container.

Patent document DE 10 2016 011 540 B3 shows a vortex tube for separating a fluid flow. Patent document DE 10 2017 113 888 B3 shows a centrifugal separator for fluid separation.

It is an object of the present invention to provide a hydrocyclone degassing device with improved characteristics.

This object is achieved by hydrocyclone degassing devices according to the independent claims. Preferred embodiments of the present invention are the subject-matter of the dependent claims.

In a first aspect, the present invention comprises a hydrocyclone degassing device for degassing a liquid, comprising a liquid pump and comprising a degassing container in which an outer liquid cyclone and an inner gas cyclone are formed along an axis of rotation, wherein the degassing container comprises at least one inlet for the liquid, at least one outlet for the liquid, and at least one extraction port for extracting gas. According to the first aspect of the present invention, the outlet of the degassing container is in hydraulic communication with the suction side of the liquid pump.

The inventors of the present invention discovered that the liquid pump located downstream of the degassing container can significantly improve the degassing performance.

According to one possible embodiment, the degassing container is configured such that the liquid flows tangentially into the degassing container via the at least one inlet. This achieves the rotating liquid flow within the degassing container.

According to one possible embodiment, the degassing container is configured in such a way that the liquid is drawn off axially from the degassing container via the at least one outlet. Such an axial extraction of the liquid is considerably easier to implement in terms of construction. In this context, the inventors discovered that a tangential discharge of the liquid is not necessary in order to achieve a sufficient degassing performance in combination with an extraction of the liquid from the degassing container.

According to one possible embodiment, the extraction port is in hydraulic connection with the suction side of a vacuum source. This provides the negative pressure by which gas is extracted from the liquid flowing through the degassing container.

According to one possible embodiment, the extraction port is axially opposite the outlet for the liquid.

According to one possible embodiment, a shut-off valve is provided between the extraction port and the suction side of the vacuum source.

In a second aspect, the present invention comprises a hydrocyclone degassing device for degassing a liquid, comprising a liquid pump and comprising a degassing container in which an outer liquid cyclone and an inner gas cyclone are formed along an axis of rotation, wherein the degassing container comprises at least one inlet for the liquid, at least one outlet for the liquid, and at least one extraction port for extracting gas, wherein the extraction port is in hydraulic communication with the suction side of a vacuum source. According to the second aspect, the vacuum source is a water jet pump arranged in a secondary hydraulic circuit.

The inventors of the present invention discovered that a water jet pump is considerably less sensitive than other types of vacuum pumps, and in particular is insensitive to liquid entering from the degassing container. In addition, high vacuum and thus high degassing performance can be achieved via a water jet pump.

According to one possible embodiment, the secondary hydraulic circuit comprises a pump, in particular a diaphragm pump, and a liquid reservoir.

According to one possible embodiment, a control system is provided which, if the level in the liquid reservoir is too high, deactivates the pump of the secondary hydraulic circuit in order to drain the liquid reservoir. Preferably, draining takes place automatically.

Preferably, the liquid reservoir comprises a level sensor for this purpose.

According to a possible embodiment, an arrangement for cooling the fluid circulating in the secondary hydraulic circuit is provided in the secondary hydraulic circuit.

In particular, this may be a chiller and/or heat exchanger.

According to one possible embodiment, a shut-off valve is provided between the extraction port and the suction side of the vacuum source. Preferably, this is controlled automatically.

The embodiment according to the second aspect is independent of the first aspect. In particular, according to the invention, a water jet pump can also be used if the liquid pump is arranged in the primary circuit upstream of the degassing container.

Conversely, the embodiment according to the first aspect can also be used independently of the second aspect. In particular, according to the invention, liquid pumps arranged downstream of the degassing container can also be used in combination with other types of vacuum generators.

Preferably, however, the features according to the first aspect are combined with those according to the second aspect.

Preferred embodiments of a hydrocyclone degassing device according to the first and/or the second aspect are described in more detail below.

According to one possible embodiment, the vacuum source generates a pressure of less than 0.3 bar abs, preferably less than 0.2 bar abs.

According to one possible embodiment, the vacuum source generates a pressure of more than 0.01 bar abs, preferably more than 0.05 bar abs.

In particular, the vacuum source generates a pressure of between 0.08 bar abs and 0.1 bar abs.

If a water jet pump is used as the vacuum source, or a pump design in which the pressure depends on the temperature, the above data on pressure refers to operation at a temperature of 25º Celsius, in particular a temperature of 25° Celsius of the liquid in the secondary circuit.

According to a possible embodiment, the hydrocyclone degassing device comprises an element arranged in a feed line to the degassing container for reducing the volumetric flow and/or pressure at the inlet, wherein preferably it is an adjusting and/or regulating element, in particular a valve and/or a pressure reducer.

For energy recovery during pressure reduction, a turbine can also be arranged at this point.

In this regard, the inventors of the present invention discovered that degassing performance can be improved if the liquid flow is throttled prior to entering the degassing container.

According to one possible embodiment, the hydrocyclone degassing device comprises a pressure equalization element arranged downstream of the pump, in particular a pressure equalization tank.

According to one possible embodiment, the at least one inlet is provided in an inlet ring which is axially connected to at least one jacket element of the degassing container.

The inlet geometry can thus be arranged in a separate element, which simplifies the design of the degassing container.

According to one possible embodiment, the inlet ring is arranged between two jacket elements of the degassing container.

According to one possible embodiment, the inlet ring comprises several inlets distributed over the circumference, which preferably open tangentially into an inner circumferential surface of the inlet ring.

According to one possible embodiment, the inlet ring comprises an inner circumferential surface into which the inlet or inlets open. The inner circumferential surface of the inlet ring preferably forms part of the inner circumferential surface of the degassing container.

According to one possible embodiment, it is provided that the inner circumferential surface of the inlet ring adjoins the inner circumferential surface of the at least one jacket element and is preferably aligned therewith.

According to one possible embodiment, the at least one inlet is arranged in a region between an axial center of the degassing container and an axial end at which the extraction port is provided.

According to one possible embodiment, the at least one inlet is arranged axially spaced from an axial position of the extraction port in the direction of the outlet side, in particular by at least 5%, preferably at least 10%, of the axial extent of the degassing container.

The spaced arrangement prevents liquid from being drawn into the extraction port and/or interfering with the cyclone in the degassing container.

According to one possible embodiment, a primary vortex element is provided in a feed line to the at least one inlet into the degassing container.

In particular, the primary vortex element may be located at the entry of an inlet channel leading to the inlet. In particular, the primary vortex element may swirl the liquid before it flows through the inlet into the degassing container. In one possible embodiment, this can be done by the primary vortex element allowing the liquid to flow tangentially into the inlet channel.

According to one possible embodiment, the primary vortex element comprises at least one primary vortex element housing having at least one tangential inlet and/or one axial outlet.

According to a possible embodiment, the degassing container comprises an upper closure plate provided with a central hole, wherein preferably the central hole of the upper closure plate forms the extraction port.

According to one possible embodiment, the degassing container comprises a lower closure plate provided with a central bore, wherein preferably the central bore of the lower closure plate forms the outlet for the liquid.

According to one possible embodiment, the degassing container comprises a rotationally symmetrical interior. Preferably, this has a cylindrical, conical and/or hyperbolic shape along its axial extension, at least over partial areas.

According to one possible embodiment, the degassing container has a basic cylindrical shape along its axial extension. This allows a particularly simple design.

According to one possible embodiment, the degassing container comprises at least one circular cylinder-shaped jacket element.

Preferably, the degassing container comprises at least two circular cylindrical jacket elements.

Preferably, the jacket element(s) connect to an inlet ring as described above.

According to one possible embodiment, the hydrocyclone degassing device comprises a plurality of degassing containers arranged in parallel and/or series. This allows the degassing performance to be increased.

According to one possible embodiment, the degassing containers, in particular as far as they are arranged in series, are operated at different negative pressure or vacuum levels.

According to one possible embodiment, the hydrocyclone degassing device forms a mobile unit.

The present invention further comprises the use of a hydrocyclone degassing device as described above for degassing a liquid.

The hydron cyclone degassing device can be used in all degassing applications.

Possible applications are, for example, the degassing of heating and/or cooling circuits and/or for the desorption of washing liquids and/or as a mobile degassing device.

The present invention further comprises a degassing container for a hydrocyclone degassing device as described above.

In particular, the degassing container comprises at least one inlet for the liquid, at least one outlet for the liquid and at least one extraction port for extracting gas. It is configured in such a way that an outer liquid cyclone and an inner gas cyclone are formed in its interior along an axis of rotation.

The degassing container preferably comprises one or more of the features described above.

For example, the degassing container may comprise an inlet ring as described above.

The degassing container according to the invention can also be used independently of the further features of the hydrocyclone degassing device according to the invention described above. In particular, it can also be used when the liquid pump is arranged upstream of the degassing container. However, it is particularly preferred to be used in a hydrocyclone degassing device according to the invention.

The present invention further comprises a method of operating a hydrocyclone degassing device for degassing a liquid, wherein liquid flows into a degassing container via at least one inlet and gas is extracted from the degassing container via at least one extraction port. It is provided that the liquid for generating the cyclone in the degassing container is pumped off from an outlet of the degassing container.

In particular, the operation can be carried out as already described above.

Furthermore, a hydrocyclone degassing device and/or a degassing container may be used as described above.

According to one possible embodiment, no rotating element is provided inside the degassing container. Therefore, only the liquid and the gas rotate, but components of the hydrocyclone degassing device do not.

According to one possible embodiment, no moveable parts are provided within the degassing container.

According to one possible embodiment, no membrane is provided in the hydrocyclone degassing device according to the present invention. Instead, the separation between the liquid and the gas takes place via the cyclone.

The present invention will now be described in more detail with reference to examples of embodiments and drawings.

The Figures show in

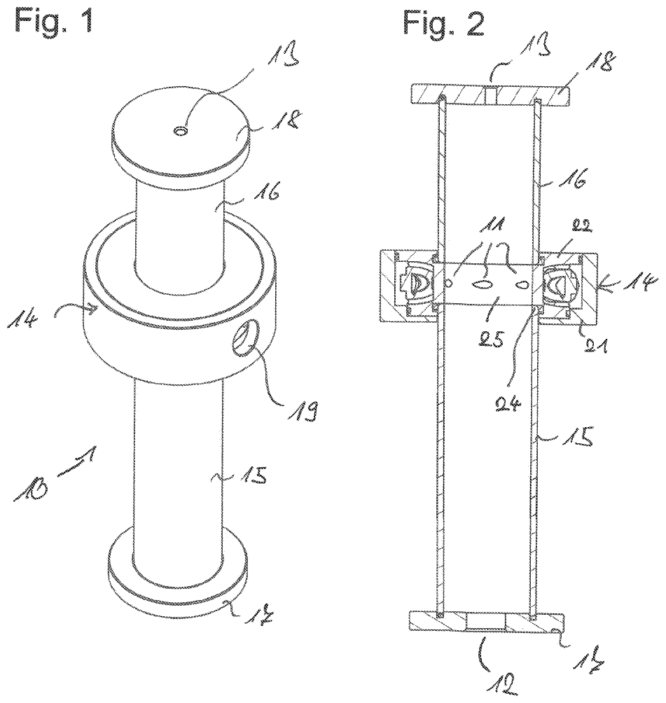

FIG. 1: an exemplary embodiment of a degassing container according to the invention in a perspective view,

FIG. 2: the exemplary embodiment of the degassing container shown in FIG. 1 in a sectional view,

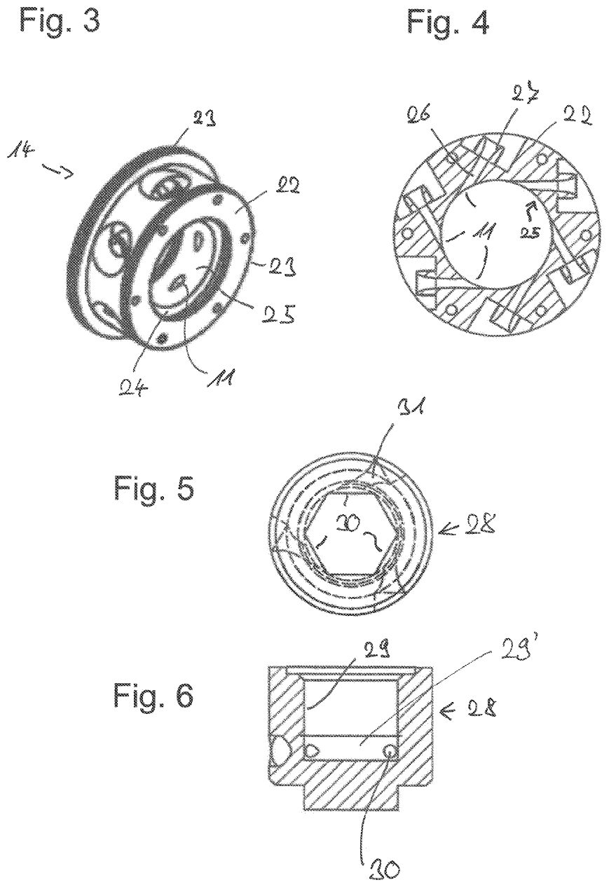

FIG. 3: a perspective view of an inlet ring used in the invention,

FIG. 4: a sectional view of the inlet ring shown in FIG. 3,

FIG. 5: a top view of a primary vortex element arranged on an inlet according to the invention,

FIG. 6: the exemplary embodiment of a primary vortex element shown in FIG. 5 in a sectional view, and

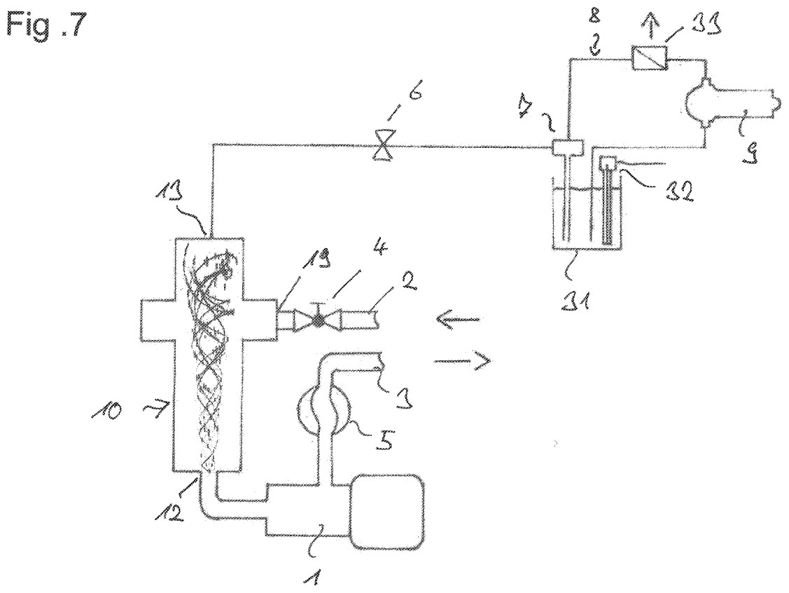

FIG. 7: an exemplary embodiment of a hydrocyclone degassing device according to the invention.

FIGS. 1 and 2 show an exemplary embodiment of a degassing container as can be used in a hydrocyclone degassing device according to the invention.

The degassing container 10 comprises an interior space into which liquid flows via one or more inlets 11 and forms an outer liquid cyclone and an inner gas cyclone in the interior space of the degassing container along an axis of rotation of the degassing container. Furthermore, an outlet 12 for the liquid and an extraction port 13 for extracting gas are provided.

In accordance with a first aspect of the present invention, the outlet 12 of the degassing container is in hydraulic communication with the suction side of the liquid pump. The inventors of the present invention discovered that significantly improved degassing performance can be achieved by placing it in the liquid pump downstream of the degassing container.

However, the degassing container shown in FIGS. 1 and 2 is also an object of the present invention independently of the arrangement of the liquid pump.

In the exemplary embodiment shown in FIGS. 1 and 2, the one or more inlets 11 are arranged in an inlet ring 14. This allows the relatively complex geometry of the inlets to be provided in a separate element which is connected to the other elements of the degassing container.

The inlet ring 14 comprises a liquid inlet 19 to which a feed line for the liquid to be degassed is connected. The liquid to be degassed flows from the liquid inlet 19 within the inlet ring to the inlet or the several inlets via which the liquid flows into the interior of the degassing container.

The inlet ring 14 comprises an annular inner circumferential surface 25 into which the inlets 11 open, and which forms part of the inner circumferential surface of the degassing container.

The inlet ring 14 is connected to one or more jacket elements 15, 16 of the degassing container, which provide the remaining inner circumferential surface of the degassing container.

In the exemplary embodiment, the inlet ring 14 is arranged between a lower jacket element 15 and an upper jacket element 16. The inner circumferential surfaces of the jacket element(s) are preferably aligned with the inner circumferential surface 25 of the inlet ring 14.

In the exemplary embodiment, the degassing container has a circular cylindrical interior. The inventors of the present invention discovered that the liquid cyclone, which is actually hyperbolically shaped, also forms with such a housing shape, and therefore more elaborate housing shapes can be dispensed with. The jacket elements 15 and 16 can hereby be formed by hollow cylindrical tubular elements. These also have a circular cross-section.

The degassing container 10 is closed at the top and bottom by closure plates 17 and 18. The upper closure plate 18 is placed on the upper jacket element 18 and closes it at the top, the lower closure plate 17 is placed on the lower jacket element 15 at the bottom and closes it at the bottom.

The upper closure plate 18 comprises a central bore 13, which forms the extraction port for extracting gas. The lower closure plate 17 also comprises a central bore 12, which serves as an outlet for the liquid.

In the exemplary embodiment of the degassing container, the discharge of the liquid is therefore axial. The inventors of the present invention discovered that the effort required for a tangential discharge is not necessary and that an axial discharge also leads to a good degassing performance.

In the exemplary embodiment, the inlet ring 14 has a step-shaped bevel 24 above and below the inner circumferential surface 25, to which the jacket elements 15 and 16 are attached. Sealing is achieved by means of sealing rings which engage on the outer circumference of the jacket elements 15, 16 and extend in grooves on the inner circumference of the step of the inlet ring.

The inlet ring comprises a jacket part 21, on which the fluid inlet 19 is arranged, and into which a fluid-carrying ring element 22 is inserted axially.

An annular space is formed between the jacket member 21 and the liquid-carrying annular member 22, through which the liquid flows from the liquid inlet 19 to the inlet regions.

FIGS. 3 and 4 show an exemplary embodiment of the fluid-carrying ring element 22. The latter is inserted into the jacket part 21 via O-ring seals 23 in a sealing manner.

The liquid-carrying ring element 22 serves as a swirl generator for the liquid flowing into the degassing container. Inlet channels 26 lead from the outer circumference of the liquid-carrying ring element to each of the inlets 11 into the degassing container. The inlet channels 26 are arranged in such a way that the liquid flows tangentially into the interior of the degassing container via the inlets 11. In particular, one axis of the inlet channels 26 extends tangentially to the surface of the inner circumferential surface 25 in the region of the respective inlet 11.

The inlet channels 26 each have a tapering cross-section, forming inlet nozzles.

According to a first variant of the present invention, the inlet channels 26 are in direct communication with the annular space via which they are supplied with liquid from the liquid connection 19. In this case, the liquid flows preferably largely laminar through the inlet channels to the respective inlet.

According to a second variant, on the other hand, a primary vortex element 28 is provided at the inlet of the inlet channels 26, via which the liquid flows into the inlet channels 26 in a swirled state. The primary vortex elements allow the degassing performance to be increased once again.

An exemplary embodiment of such a primary vortex element 28 is shown in FIGS. 5 and 6. In the exemplary embodiment, the primary vortex element has a cap shape, and is arranged with its inner circumference on an outer circumference of the inlet portion 27 of the inlet channels 26.

The primary vortex element 28 comprises one or more primary inlets 30 through which fluid flows tangentially into the primary vortex element. The liquid rotating in this way then flows further into the inlet channel 26 and from there to the respective inlet 11 in the degassing container.

For this purpose, the primary vortex element 28 comprises one or more primary inlet channels 31, which lead through a jacket region of the primary vortex element to the primary inlets 30. The primary inlet channels 31 each have a cross-section tapering in the direction of flow and therefore form nozzles.

The primary vortex element closes the inlet channel at its entry in the axial direction, and introduces the liquid tangentially into it. For this purpose, the primary inlets 30 are arranged in a region 29′ of the inner circumferential surface of the primary vortex element which, after arrangement at the entry region 27 of the inlet channel 26, is axially adjacent to the entry to the inlet channel.

An inner periphery 29 of the primary swirl member is disposed on the outer periphery of the entrance portion 27, for example, the primary swirl member is slid onto or bolted to the entrance portion 27.

In the exemplary embodiment, the inlet areas 27 for the inlet channels 26 are recessed into an outer circumference of the liquid-carrying ring element, in particular milled into it.

Likewise, the inlet channels 26 as well as the primary inlet channels 31 are preferably milled into the respective elements.

In the exemplary embodiment, the inlets 11 into the degassing container are arranged axially spaced from the extraction port 13 and/or the upper closure plate 18. In particular, the upper jacket element 16 is arranged between the inlet ring 14 and the upper closure plate 18. This prevents liquid from being drawn off via the extraction port 13.

In alternative embodiments, however, the inlets 11 or the inlet ring 14 could also be arranged directly below the extraction port 13 and/or the upper closure plate 18.

Preferably, the inlet(s) 11 or the inlet ring 14 are arranged in a region between the axial center of the degassing container and the degassing opening 13 and/or upper closure plate 18. Particularly preferably, however, the inlet(s) 11 or the inlet ring are axially spaced therefrom, in particular by at least 5% of the axial extent of the degassing container, further preferably by at least 10%. In particular, the axial distance can be at least 20% of the axial extent of the degassing container.

The axial height of the inner circumferential surface 25 of the inlet ring is preferably less than 20% of the axial extent of the degassing container, more preferably less than 10% of the axial extent.

The degassing container can be joined together to form a unit by tensioning elements not shown in the figures, for example in the form of racks or tensioning bolts, which run axially from the upper closure plate 18 to the lower closure plate 17. The tension elements can pass through corresponding openings in the inlet ring 14. Alternatively, each of these can also be connected to the inlet ring 14.

The individual components of the degassing container described above can each also be used independently as part of an otherwise differently configured degassing container.

In particular, the interior of the degassing container can be conical and/or hyperbolic in shape. For example, differently shaped jacket elements 15 and/or 16 can be used for this purpose.

FIG. 7 shows an exemplary embodiment of a hydrocyclone degassing device according to the invention. Preferably, this hydrocyclone degassing device uses a degassing container as just described and/or shown in FIGS. 1-6. However, the hydrocyclone degassing device shown in FIG. 7 can also be operated with any other design of degassing container.

In the exemplary embodiment shown in FIG. 7, the primary liquid circuit of the hydrocyclone degassing device comprises ports 2 and 3 for a feed line for the liquid to be degassed and an outlet line for the degassed liquid.

The port 2 for the feed line is in fluid communication with the inlet(s) of the degassing container 10 via the liquid inlet 19 of the degassing container, and the port 3 for the outlet line is in fluid communication with the outlet 12 of the degassing container.

In accordance with one aspect of the present invention, a fluid pump 1 is provided between the outlet 12 of the degassing container and the port 3 for the outlet line. The suction side of the liquid pump 1 is therefore in fluid communication with the outlet 12 of the degassing container and draws the liquid from the degassing container.

The liquid pump 1 is in particular a centrifugal pump, preferably a multi-stage centrifugal pump.

In the exemplary embodiment, a pressure equalization tank 5 is further provided between the outlet line connection 3 and the liquid pump 1 to reduce the pressure of the liquid exiting the hydrocyclone degassing device. However, the pressure equalization tank 5 is optional.

According to a further aspect of the present invention, a member 4 for throttling the volumetric flow entering the degassing container is provided between the feed line connection 2 and the inlet to the degassing container, in this case between the connection 2 and the liquid inlet 19. In the exemplary embodiment, this is a throttle valve 4. In particular, it is an adjustable throttle valve.

Alternatively, a pressure reducer could be used. Furthermore, a turbine could also be used as a throttling device to enable energy recovery.

The inventors of the present invention discovered that throttling the volumetric flow entering the degassing container is of critical importance to the degassing performance.

In the exemplary embodiment of the hydrocyclone degassing device, the extraction port 13 is in communication with a vacuum source. In the exemplary embodiment, the extraction port 13 is axially opposite the outlet 12.

In the exemplary embodiment, a shut-off valve 6 is provided in the vacuum line between the extraction port 13 and the vacuum source. The shut-off valve can be a magnetic valve in particular.

According to another aspect of the present invention, a water jet pump 7 is used as a vacuum source, which is arranged in a secondary hydraulic circuit 3. The inventors of the present invention discovered that such a water jet pump can, on the one hand, generate very deep vacuums and, on the other hand, is robust with respect to liquid flowing in from the degassing container.

The secondary fluid circuit 8 includes a liquid reservoir 31 from which a pump 9 pumps fluid out and pumps it to the water jet pump 7, from which the fluid flows back into the liquid reservoir 31.

The pump 9 of the secondary hydraulic circuit may in particular be a diaphragm pump.

In the exemplary embodiment, the liquid reservoir 31 comprises a level sensor 32, via which the level of the liquid reservoir 31 is monitored. Furthermore, a controller is provided which drains the liquid reservoir 31 if the fill level is too high.

To drain the liquid reservoir 31, the pump 9 in the secondary hydraulic circuit is stopped so that fluid is drawn out of the liquid reservoir 31 by the vacuum in the degassing container via the water jet pump 7 into the degassing container.

Via the shut-off valve 6, the connecting line between the extraction port 13 and the water jet pump 7 is closed as soon as the level in the liquid reservoir 31 falls below a lower limit value. The secondary hydraulic circuit can then be put back into operation and shut-off valve 6 opened.

Since the efficiency of the water jet pump 7 depends on the temperature of the fluid in the secondary hydraulic circuit, an arrangement for cooling the fluid circulating in the secondary hydraulic circuit may be provided. In the exemplary embodiment, a heat exchanger 33 is provided which cools the fluid.

The present invention thus provides a hydrocyclone degassing device in which the cyclone is generated by a pump. According to one aspect, the pump is arranged at the outlet of the degassing container.

According to a further aspect, primary swirling is provided at the entrance of the inlets to the degassing container such that primary and secondary swirling occurs.

According to a further aspect, the device provides a purge and degassing combination.

The present invention thus enables vacuum degassing without the use of a membrane. Here, the following parameters are important for effective and efficient vacuum degassing:
large contact surface between the liquid to be degassed and the vacuum
small droplets or low layer thicknesses for short diffusion paths
pressure level as low as possible
long residence time or high throughput.

These parameters are served by the various aspects of the present invention. In particular, a certain, preferably adjustable, volumetric flow rate is continuously passed through the degassing container in a single or multi-stage vortex or swirl such that a constant gas column is formed in the center thereof. The gas column provides a large surface area for the separation of free gas bubbles, dissolved gases and the dissolved gases released in the inlet nozzles.

In this regard, the present invention provides a continuous degassing process with a high degassing capacity and a purging function.

The hydrocyclone degassing device according to the invention operates continuously with a constant, preferably adjustable volume flow. The volume flow can be adjusted in particular via the pumping capacity of the liquid pump and/or via the throttling element, which is provided downstream of the degassing container.

Relative to the size of the degassing container, the technology according to the invention has a high degassing performance.

Furthermore, a purging function is preferably provided. Degassing takes place in a continuous process. Here, a volume flow is continuously degassed so that the hydrocyclone degassing device can be used for purging purposes. Thus, gas bubbles usually adhere to surfaces and are transported directly into the degassing container with the purging flow.

If the hydrocyclone degassing device is used as a mobile purging and degassing device, the pump is preferably configured to provide not only degassing (internal pressure losses) but also a flow in the fluid system to which it is connected, i.e. e.g. pipelines or heat exchangers, in order to purge adhering bubbles directly into the degassing container.

In particular, the mobile purging and degassing device can therefore be used for commissioning a fluid system such as a piping system to purge and degas it before commissioning.

In the prior art, the purging option does not exist. Thus, the liquid must first be undersaturated in order to dissolve gas bubbles elsewhere. This is significantly less efficient.

Therefore, if the mobile purging and degassing device is operated in stationary use where such a purging function is not required, a throttling element can be provided upstream of the degassing container and/or its throttling function can be increased and/or activated to increase the degassing efficiency.

The throttling element can be omitted in the case of a stationary deaerator, but a turbine is then used at this point for energy recovery, especially in large-scale plants.

The hydrocyclone degassing device according to the invention can be used in particular as a mobile degassing device. However, the hydrocyclone degassing device can also be used as a stationary device.

The device can be used in particular for degassing pipelines, for example surface heaters or heat exchangers or other components of heating and/or cooling devices.

The basic structure of an embodiment of the hydrocyclone degassing device is again summarized below:

The suction side of a liquid pump 1, in particular a multistage, preferably self-priming centrifugal pump, is in fluidic connection with the outlet 12 of the degassing container 10. The pressure side of the liquid pump 1 conveys the degassed or partially degassed fluid back into the system, wherein the pressure equalization is ensured either in the system to be degassed or as an additional component by means of a pressure equalization vessel 5 in the device.

The liquid to be degassed flows tangentially into the degassing container 10, which is under negative pressure, via an optional primary swirl or vortex, so that a (secondary) swirl or vortex is created. Upstream of the inlet to the degassing container is an optional filter screen and an element 4 for throttling the incoming volume flow. A rotating gas column forms in the center of the degassing container.

A vacuum generator is connected to the extraction port 13 to evacuate the released gas from the degassing container 10. In particular, a secondary water circuit with a diaphragm pump that supplies a water jet pump can be used as a vacuum generator.

To increase the volume flow and/or the degassing performance, several degassing containers and/or hydrocyclone degassing devices according to the present invention can be connected in parallel or serially. In the case of serial connection, the individual degassing containers 10 can, in particular, be operated at different pressure levels in order to separate gas fractions with different solubilities thereby.

The degassing container may have a cylindrical, conical, or hyperbolically tapering interior.

The secondary water circuit may comprise a reservoir with a capacitive level sensor, wherein the control system deactivates the diaphragm pump of the secondary water circuit when the level is too high in order to drain the reservoir. A shut-off valve 6, in particular in the form of a magnetic valve, is located between the extraction port 13 of the degassing reservoir and the vacuum generator, in particular the suction tract of the water jet pump.

The vacuum source, in particular the water jet pump, preferably generates a low absolute pressure of less than 0.2 bar abs. In particular, it generates an absolute pressure of between 0.08-0.01 bar abs at 25° C. The achievable absolute pressure depends on the water temperature when a water jet pump is used. If necessary, a cooling arrangement can therefore be used to cool the water in the secondary water circuit.

However, another form of vacuum pump can be used instead of the water jet pump.

The hydrocyclone degassing device can be used in particular as a mobile purging and degassing device, and can be connected by plant constructors and/or plant operators to water-bearing plants in order to degas the water circulating there.

It is also conceivable to extract gas from the liquid flow in geothermal plants.

The hydrocyclone degassing device preferably has a volume flow of at least ten liters per minute, preferably of at least 20 liters per minute. In other applications, a volume flow of at least 50 liters per second, preferably of at least 100 liters per second, is also conceivable.

1. A hydrocyclone degassing device for degassing a liquid, comprising a liquid pump and comprising a degassing container in which an outer liquid cyclone and an inner gas cyclone are formed along an axis of rotation, wherein the degassing container comprises at least one inlet for the liquid, at least one outlet for the liquid and at least one extraction port for extracting gas,
wherein
the at least one outlet of the degassing container is in hydraulic connection with a suction side of the liquid pump.

2. The hydrocyclone degassing device according to claim 1, wherein the degassing container is configured such that the liquid flows tangentially into the degassing container via the at least one inlet and/or wherein the degassing container is configured such that the liquid is withdrawn axially from the degassing container via the at least one outlet.

3. The hydrocyclone degassing device according to claim 1, wherein the at least one extraction port is in hydraulic connection with a suction side of a vacuum source, wherein the at least one extraction port is preferably axially opposite the at least one outlet for the liquid and/or wherein a shut-off valve is between the at least one extraction port and the suction side of the vacuum source, which is automatically controlled.

4. A hydrocyclone degassing device for degassing a liquid, comprising a liquid pump and a degassing container, in which an outer liquid cyclone and an inner gas cyclone are formed along an axis of rotation, wherein the degassing container comprises at least one inlet for the liquid, at least one outlet for the liquid and at least one extraction port for extracting gas, wherein the at least one extraction port is in hydraulic connection with the suction side of a vacuum source,
wherein
the vacuum source is a water jet pump which is arranged in a secondary hydraulic circuit.

5. The hydrocyclone degassing device according to claim 4, wherein the secondary hydraulic circuit comprises a pump and a liquid reservoir, wherein a control is provided which deactivates the pump of the secondary hydraulic circuit when a filling level is too high in order to empty the liquid reservoir, wherein the liquid reservoir comprises a filling level sensor, and/or wherein an arrangement for cooling fluid circulating in the secondary hydraulic circuit is provided in the secondary hydraulic circuit and/or wherein a shut-off valve is provided between the at least one extraction port and the suction side of the vacuum source, which valve is controlled automatically.

6. The hydrocyclone degassing device according to claim 3, wherein the vacuum source generates a pressure of less than 0.3 bar abs; and/or wherein the vacuum source generates a pressure of more than 0.01 bar abs.

7. The hydrocyclone degassing device according to claim 1, comprising an element arranged in a feed line to the degassing container for reducing volume flow and/or pressure at the at least one inlet and/or an element arranged in a feed line to the degassing container for energy recovery and/or comprising a pressure equalization element arranged downstream of the liquid pump.

8. The hydrocyclone degassing device according to claim 1, wherein the at least one inlet is provided in an inlet ring which is axially adjacent to at least one jacket element of the degassing container and is arranged between two jacket elements of the degassing container, wherein the inlet ring comprises several inlets distributed over the circumference, which open tangentially into an inner circumferential surface of the inlet ring, and/or wherein the inlet ring comprises an inner circumferential surface which adjoins an inner circumferential surface of the at least one jacket element and is aligned therewith.

9. The hydrocyclone degassing device according to claim 1, wherein the at least one inlet is arranged in a region between an axial center of the degassing container and an axial end at which the at least one extraction port is provided, and/or wherein the at least one inlet is arranged spaced axially from an axial position of the at least one extraction port in a direction of an outlet side by at least 5% of an axial extent of the degassing container.

10. The hydrocyclone degassing device according to claim 1, wherein a primary vortex element is provided in a feed line to the at least one inlet into the degassing container, wherein the primary vortex element comprises at least one primary vortex housing having at least one tangential inlet and/or one axial outlet.

11. The hydrocyclone degassing device according to claim 1, wherein the degassing container comprises an upper closure plate provided with a central bore and/or a lower closure plate provided with the central bore, wherein the central bore of the upper closure plate forms the at least one extraction port and/or the central bore of the lower closure plate forms the at least one outlet for the liquid, and/or wherein the degassing container has a rotationally symmetrical interior, which has a cylindrical, conical and/or hyperbolic shape along its axial extension, and/or wherein the degassing container comprises at least one circular cylindrical jacket element.

12. The hydrocyclone degassing device according to claim 1, comprising a plurality of degassing containers arranged in parallel and/or series, wherein the plurality of degassing containers are operated at different vacuum levels.

13. A method of using the hydrocyclone degassing device according to claim 1 for degassing heating and/or cooling circuits and/or for desorbing washing liquids and/or as a mobile degassing device.

14. A degassing container for the hydrocyclone degassing device according to claim 1.

15. A method for operating the hydrocyclone degassing device according to claim 1, wherein liquid flows into the degassing container via the at least one inlet and gas is extracted from the degassing container via the at least one extraction port,
wherein
the liquid for generating the cyclone in the degassing container is pumped off from a drain of the degassing container.

16. The hydrocyclone degassing device according to claim 5, wherein the pump is a diaphragm pump, and the arrangement for cooling the fluid circulating in the secondary hydraulic circuit is provided in the form of a chiller and/or heat exchanger.

17. The hydrocyclone degassing device according to claim 6, wherein the vacuum source generates a pressure of less than 0.2 bar abs, and/or wherein the vacuum source generates a pressure of more than 0.05 bar abs, in particular a pressure between 0.08 bar abs and 0.1 bar abs.

18. The hydrocyclone degassing device according to claim 7, wherein the element arranged in the feed line to the degassing container for reducing volume flow and/or pressure at the at least one inlet is an adjusting and/or regulating element, in particular a valve and/or a pressure reducer.

19. The hydrocyclone degassing device according to claim 7, wherein the element arranged in the feed line to the degassing container for energy recovery is a turbine.

20. The hydrocyclone degassing device according to claim 9, wherein the at least one inlet is arranged spaced axially from the axial position of the at least one extraction port in the direction of the outlet side by at least 10% of the axial extent of the degassing container.
